(19) United States
(12) Patent Application Publication
(10) Pub. No.: US 2004/0178538 A1
(43) Pub. Date: Sep. 16, 2004

(54) In-mold degating system

(75) Inventor: Gary L. Fouts, Anderson, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, Pendleton, IN (US)

(21) Appl. No.: 10/388,938

(22) Filed: Mar. 14, 2003

(51) Int. Cl. B29C 45/40

(52) U.S. Cl. 264/334; 425/DIG. 51; 425/556

(57) ABSTRACT

An apparatus for making a molded article comprises a cavity block, a slide and an actuator. The cavity block includes a mold cavity for forming the molded article and a runner for delivering the polymeric resin to the mold cavity. The slide is positioned adjacent to the cavity block and includes a bore extending through the slide and a gate formed in the slide. The gate of the slide is positioned to connect the runner to the mold cavity by forming a passage from the runner to the mold cavity. The actuator is operable to move the slide to a second position where the gate does not connect the runner to the mold cavity and no continuous passage from the runner to the mold cavity is available through the gate.

### BACKGROUND

The present invention relates to the field of injection molding using a polymeric resin, and in particular to a method for automatically degating a molded article.

Parts made by injection molding typically come out of the mold with runners and gates still attached to the parts. Before the parts may be used, the runners and gates must be removed from the parts. Unfortunately, this is a costly problem. First, humans typically remove the parts from the runners and gates. This is not only costly from a man-hour standpoint, but also raises ergonomic concerns from the repetitive motions of removing runners and gates from parts. Second, when the runners and gates are removed from the parts, a clean break does not always occur, and excess plastic may remain on the part. This is problematic for parts that need to be molded to specific tolerances. This can also be problematic because the excess plastic can produce undesirable sharp edges. Third, the gates connected to the parts are sometimes undesirably strong, and the process of removing the parts from the gates may cause the parts themselves to break such that a portion of the part remains with the removed gate. For the above reasons, it would be desirable to have a tool for molding parts that allows the parts to be removed from the runners and gates while still in the mold.

### SUMMARY

The present invention is directed to an apparatus for automatically degating a molded article formed of a polymeric resin. The apparatus comprises a cavity block including a mold cavity for forming the molded article and a runner for delivering the polymeric resin to the mold cavity. A moveable slide is positioned adjacent to the cavity block, the slide including an angled bore extending through the slide and a gate formed in the slide. The slide is operable to be positioned in a first position where the gate connects the runner to the mold cavity by forming a continuous passage from the runner to the mold cavity. The slide is also operable to be moved to a second position where the gate does not connect the runner to the mold cavity and no continuous passage from the runner to the mold cavity is available through the gate.

An actuator is provided including an angled cam driver positioned on top of a base portion. The angled cam driver extends into the bore of the slide. The base portion is connected to a hydraulic cylinder that is operable to move the base portion in a linear direction upon an axis. Movement of the actuator causes the slide to move between the first position where a continuous passage is formed by the runner, the gate, and the mold cavity and the second position where the passage between the runner, the gate and the mold cavity is broken.

### BRIEF DESCRIPTION OF THE DRAWINGS

FIG. 1 is a cross-sectional view of an apparatus for forming a molded article, including a cavity block, a slide and an actuator, where the slide is shown in a first position; and

FIG. 2 is a second cross-sectional view of the apparatus of FIG. 1 with the slide shown in the second position.

### DESCRIPTION

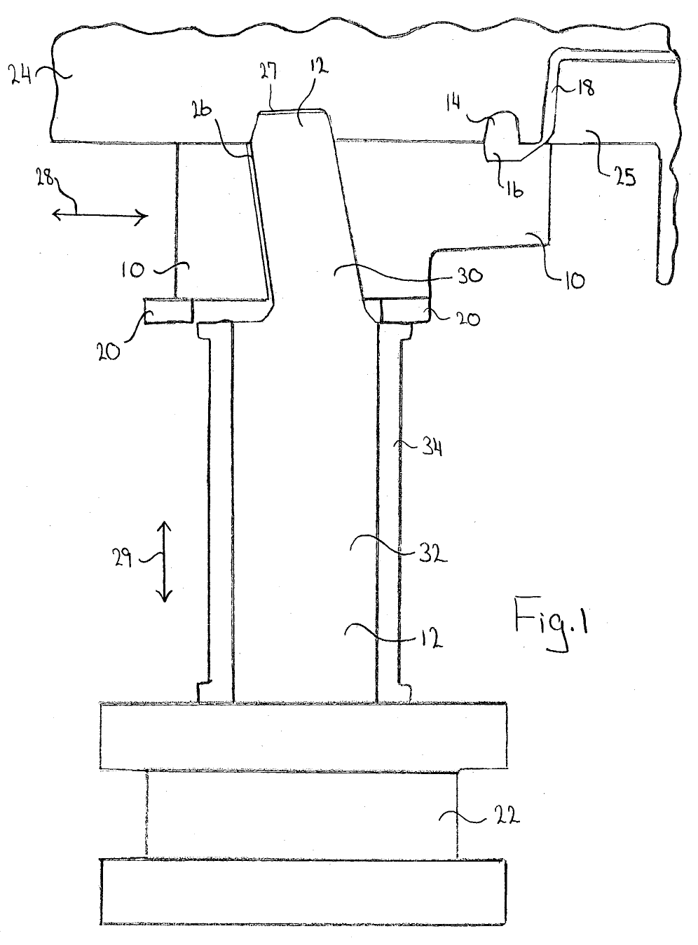

The present invention provides an apparatus for removing molded parts from their associated runners and gates. A cross-section of one embodiment of the present invention is shown in FIG. 1. The apparatus includes a moveable slide 10 positioned adjacent to the cavity block 24 of a mold. An actuator 12 interacts with slide 10 to move slide in the direction of arrow 28.

The cavity block 24 includes a channel forming the runner 14 and a mold cavity 18. In particular, the runner is designed to receive polymeric resin material and deliver such material to the mold cavity 18. The mold cavity 18 is designed in the shape of the desired molded part to be output from the mold. The cavity block 24 includes a removable portion 25 that splits the mold cavity 18 in half such that the molded part may be removed from the mold. The cavity block 24 also includes a recess 27 formed along a wall of the cavity block. The cavity block is made of steel or other materials known in the art for use in molds.

The moveable slide 10 is positioned adjacent to the cavity block 24. The slide 10 is slightly removed from the cavity block (e.g., 0.001 mm of separation). The slide 10 includes a angled central bore 26 that extends through the slide. The slide also includes a recessed portion that forms a gate 16.

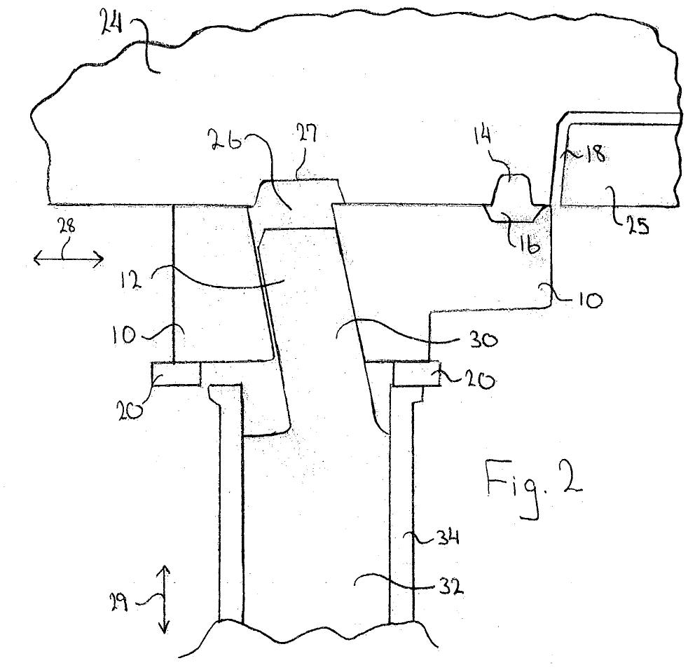

The slide is moveable between a first position (see FIG. 1) and a second position (see FIG. 2) along the direction of arrow 28. In the first position, the gate 16 connects the runner 14 to the mold cavity 18. In particular, when the slide is in the first position, a continuous channel is formed through runner 14, gate 16 and mold cavity 18. The narrowest portion of such channel is located between gate 16 and mold cavity 18. When the slide is moved to the second position, the continuous channel between runner 14, gate 16 and mold cavity 18 is broken. On the opposite side of the slide 10 from the cavity block 24, a wear pad 20 provides a surface for the slide 10 to ride upon as it moves between the first position and the second position. The slide is made of any acceptably hard material (e.g., steel) to withstand the repetitive interaction with the cavity block, actuator and molded parts within the cavity block.

An actuator 12 is provided to interact with the slide 10 and move the slide between the first position and the second position. The actuator 12 includes a cam driver portion 30 and a cylindrical base portion 32. The cam driver 30 of the actuator 12 extends at an angle from the cylindrical base portion 32 and is positioned within the bore 26 of slide 10. A lubricating material is provided on the cam driver 30 to allow the cam driver to easily slide within the bore 26. When the cam driver 30 is fully inserted into the bore 26, the top of the cam driver engages the recess 27 in the cavity block 24. Cylindrical portion 32 of the actuator 12 is retained within a bushing 34 for support. A hydraulic cylinder 22 is connected to the actuator 12 to cause the actuator to move up and down in a linear direction along the axis of the cylindrical base portion in the direction of arrow 29. The actuator 12, and particularly the cam driver 30, is made of any acceptably hard material (e.g., steel) to withstand the repetitive interaction with the slide.

In operation, molten plastic is injected into the cavity block through the runner 14. The molten plastic flows down the runner 14, through the gate 16, and into the mold cavity 18. The channel formed by the runner 14, gate 16 and mold cavity 18 is shown in FIG. 1. When the plastic in the mold cavity 18 is nearly hardened, but plastic still retains some softness, the hydraulic cylinder 22 moves the actuator 12 downward. As shown in FIG. 2, downward movement of the actuator 12 causes the cam driver 30 to act against the walls in the slide defining the bore 26, thereby moving the slide slightly to the left. This movement of the slide to the left results in a disconnection of the gate 16 from the mold cavity 18, and a clean break is made between the part and the gate. The plastic in the mold then completely hardens, and the removable portion 25 of the cavity block is separated from the rest of the cavity block. With the mold in this open position, the part formed in the cavity block 18 is removed from the mold with no plastic from the gate or runner attached to the part. The hardened plastic from the gate and runner is then removed from the mold and the hydraulic cylinder moves the actuator back to an upward position with the cam driver 30 fully inserted into the bore 26 of the slide (i.e., the position shown in FIG. 1). The entire process may then be repeated to produce another molded part.

Although the present invention has been described in considerable detail with reference to certain preferred versions thereof, other versions are possible. For example, although only one runner and mold cavity has been described for each cavity block, the cavity block could have a number of runners and/or mold cavities. Likewise, a number of gates could be included on each slide. Furthermore, a number of different actuator types and configurations could be used to compel movement of the slide. Therefore, the spirit and scope of the appended claims should not be limited to the description of the preferred versions contained herein.

What is claimed is:

1. An apparatus for forming a molded article using a polymeric resin, the apparatus comprising:
a. a cavity block including a mold cavity for forming the molded article and a runner for delivering the polymeric resin to the mold cavity;
b. a slide positioned adjacent to the cavity block, the slide including a bore and a gate, wherein the slide is moveable between a first position where the gate connects the runner to the mold cavity and a second position where the gate does not connect the runner to the mold cavity; and
c. an actuator extending into the bore of the slide, wherein movement of the actuator causes the gate to move between the first position and the second position.

2. The apparatus of claim 1 wherein the actuator includes a base portion and cam driver that extends into the bore of the slide.

3. The apparatus of claim 2 wherein the cam driver is angled with respect to the base portion of the actuator.

4. The apparatus of claim 3 wherein the base portion is moveable along an axis.

5. The apparatus of claim 4 wherein the base portion is moved by a hydraulic cylinder.

6. The apparatus of claim 1 wherein the bore extends through the slide.

7. An apparatus for forming a molded article using a polymeric resin, the apparatus comprising:
a. a cavity block including a cavity for forming the molded article and a runner for delivering the polymeric resin to the cavity;
b. a slide positioned adjacent to the cavity block, the slide including a bore and a gate; and
c. an actuator having a base portion and an angled cam driver, the angled cam driver positioned within the bore of the slide, the actuator operable to move along an axis wherein movement of the actuator along the axis moves the cam driver within the bore and causes the slide to move with respect to the cavity block.

8. The apparatus of claim 7 wherein the slide is moveable between a first position and a second position wherein the gate of the slide connects the runner to the cavity in the first position and does not connect the runner to the cavity in the second position.

9. The apparatus of claim 8 wherein the slide moves in a liner direction between the first position and the second position.

10. A method for degating a molded article formed in a mold having a runner, a gate and a mold cavity, the method comprising the steps of:
a. providing a cavity block comprising the runner and the mold cavity with the runner disconnected from the mold cavity in the cavity block;
b. providing a slide positioned adjacent to the cavity block, the slide comprising the gate such that the runner, slide and mold cavity are all interconnected, the slide further comprising a bore;
c. providing an actuator positioned within the bore; and
d. moving the actuator in a linear direction to disconnect the gate from the mold cavity.

11. The method of claim 10 wherein a hydraulic cylinder is used to provide linear movement to the actuator.

12. The method of claim 10 wherein the actuator comprises a base portion and an angled cam driver.

13. An apparatus for degating a molded article formed of a polymeric resin in a mold, the mold having a runner, a gate, and a mold cavity, the apparatus comprising:
a. a cavity block including the mold cavity for forming the molded article;
b. a slide positioned adjacent to the cavity block, the slide including a bore and a gate, wherein the slide is moveable between a first position where the gate connects the runner to the mold cavity and a second position where the gate does not connect the runner to the mold cavity; and
c. an actuator extending into the bore of the slide, wherein movement of the actuator causes the gate to move between the first position and the second position.

14. The apparatus of claim 13 wherein the actuator includes a base portion and cam driver that extends into the bore of the slide.

15. The apparatus of claim 14 wherein the cam driver is angled with respect to the slide.

16. The apparatus of claim 15 wherein the base portion is moveable along an axis.

17. The apparatus of claim 16 wherein the base portion is moved by a hydraulic cylinder.

18. The apparatus of claim 13 wherein the bore extends through the slide.

19. The apparatus of claim 13 wherein the cavity block further includes the runner.
